(19) United States
(12) Patent Application Publication
(10) Pub. No.: US 2025/0039331 A1
(43) Pub. Date: Jan. 30, 2025

(54) VIDEO TRANSMISSION SYSTEM AND VIDEO TRANSMISSION METHOD

(71) Applicant: TOYOTA JIDOSHA KABUSHIKI KAISHA, Toyota-shi (JP)

(72) Inventor: Hirofumi MOMOSE, Numazu-shi (JP)

(73) Assignee: TOYOTA JIDOSHA KABUSHIKI KAISHA, Toyota-shi (JP)

(21) Appl. No.: 18/771,252

(22) Filed: Jul. 12, 2024

(30) Foreign Application Priority Data
Jul. 25, 2023 (JP) 2023-120542

(51) Int. Cl. H04N 7/01; H04N 7/18

(52) U.S. Cl. CPC H04N 7/0127; H04N 7/183

(57) ABSTRACT

A video transmission system transmits a video from a moving body that is a target of remote driving by a remote driver to a terminal on a side of the remote driver. The video transmission system executes an active operation determining process to detect or predict an active operation in which a degree of intensity of a driving operation by the remote driver exceeds a first threshold value, and a video quality increase process to increase quality of a video transmitted to the terminal during a first period after the active operation is detected or predicted, as compared with during a period other than the first period.

### CROSS-REFERENCE TO RELATED APPLICATION

This application claims priority to Japanese Patent Application No. 2023-120542 filed on Jul. 25, 2023, the entire contents of which are incorporated by reference herein.

### TECHNICAL FIELD

The present disclosure relates to a technique for transmitting a video from a moving body that is a target of remote driving by a remote driver to a terminal on the remote driver side.

### BACKGROUND ART

Patent Literature 1 discloses a technique for remotely monitoring an autonomous driving vehicle. The autonomous driving vehicle transmits a video captured by a camera to the monitoring control server. The monitoring control server receives a video transmitted from the autonomous driving vehicle. When the key frame of the video is not received within a predetermined time, the monitoring control server transmits an emergency control signal to the autonomous driving vehicle. The autonomous driving vehicle limits the speed or makes an emergency stop in accordance with the emergency control signal.

Patent Literature 2 discloses a technique for remotely monitoring an autonomous driving vehicle. An autonomous driving control device mounted on the autonomous driving vehicle transmits detection data detected by a detecting unit of a camera to a remote monitoring center. The autonomous driving control device calculates a current degree of risk of the autonomous driving vehicle. The autonomous driving control device increases an amount of detection data to be transmitted to the remote monitoring center as the degree of risk of the autonomous driving vehicle increases.

### LIST OF RELATED ART

Patent Literature 1: Japanese Patent Application Laid-Open No. 2019-003403
Patent Literature 2: International Publication No. WO 2018/155159

### SUMMARY

Remote driving of a moving body by a remote driver will be considered. The moving body transmits a video necessary for the remote driving to a remote driver terminal. Providing a high-quality video to the remote driver is preferable from a viewpoint of accuracy of the remote driving by the remote driver. However, as the video quality becomes higher, an amount of transmission data and a communication cost increase.

An object of the present disclosure is to provide a technique capable of ensuring the accuracy of the remote driving and reducing the communication cost in the remote driving of the moving body by the remote driver.

A first aspect relates to a video transmission system for transmitting a video from a moving body that is a target of remote driving by a remote driver to a terminal on a side of the remote driver.

The video transmission system comprises processing circuitry configured to execute:
an active operation determining process to detect or predict an active operation in which a degree of intensity of a driving operation by the remote driver exceeds a first threshold value, and
a video quality increase process to increase quality of a video transmitted to the terminal during a first period after the active operation is detected or predicted, as compared with during a period other than the first period.

A second aspect relates to a video transmission method for transmitting a video from a moving body that is a target of remote driving by a remote driver to a terminal on a side of the remote driver.

The video transmission method includes:
an active operation determining process to detect or predict an active operation in which a degree of intensity of a driving operation by the remote driver exceeds a first threshold value, and
a video quality increase process to increase quality of a video transmitted to the terminal during a first period after the active operation is detected or predicted, as compared with during a period other than the first period.

According to the present disclosure, the video quality of the video transmitted from the moving body to the terminal on the remote driver side is dynamically changed, not uniformly set. Specifically, the video quality is increased during the first period after the active operation by the remote driver is detected or predicted. When performing an active operation, the remote driver observes a situation around the moving body particularly carefully. The accuracy of the remote driving by the remote driver is improved, since the video quality is increased at that time.

The video quality in the period other than the first period is set to be lower than that in the first period. Since the remote driver does not perform an active operation in the period other than the first period, the accuracy of the remote driving is secured without increasing the video quality more than a necessary level. Even though the video with normal quality is provided, the remote driver can continue the remote driving of the moving body with sufficient accuracy. Since the video quality is set to be relatively low, the amount of transmission data and the communication cost are reduced.

As described above, according to the present disclosure, it is possible to ensure the accuracy of the remote driving and to reduce the communication cost. In other words, it is possible to achieve both the securement of the accuracy of the remote driving and the reduction of the communication cost.

### BRIEF DESCRIPTION OF DRAWINGS

FIG. 1 is a schematic diagram showing a configuration example of a remote driving system;

FIG. 2 is a conceptual diagram showing a relationship between an active operation by a remote driver and video quality;

FIG. 3 is a conceptual diagram for explaining an example of key frame control;

FIG. 4 is a conceptual diagram for explaining an example of video quality control in consideration of vehicle speed;

FIG. 5 is a timing chart showing an example of video quality control in consideration of the active operation;

FIG. 6 is a conceptual diagram for explaining an example of detection and restoration of the active operation;

FIG. 7 is a block diagram showing an example of a functional configuration of a video transmission system;

FIG. 8 is a flowchart summarizing video quality control in consideration of the active operation;

FIG. 9 is a block diagram showing an example of a configuration of a vehicle;

FIG. 10 is a block diagram showing an example of a configuration of a remote driver terminal;

FIG. 11 is a block diagram showing a first example of the active operation determining unit;

FIG. 12 is a block diagram showing a second example of the active operation determining unit;

FIG. 13 is a block diagram showing a third example of the active operation determining unit;

FIG. 14 is a block diagram showing a fourth example of the active operation determining unit; and

FIG. 15 is a block diagram showing a fifth example of the active operation determining unit.

### DETAILED DESCRIPTION

Embodiments of the present disclosure will be described with reference to the accompanying drawings.

### 1. Overview of Remote Driving System

Remote driving of a moving body will be considered. Examples of the moving body include a vehicle, a robot, etc. The vehicle may be an autonomous driving vehicle. Examples of the robot include a distribution robot, a work robot, etc. As an example, in the following description, a case where a moving body which is a target of the remote driving is a vehicle will be considered. “vehicle” in the following description can be generalized by being replaced with “moving body”.

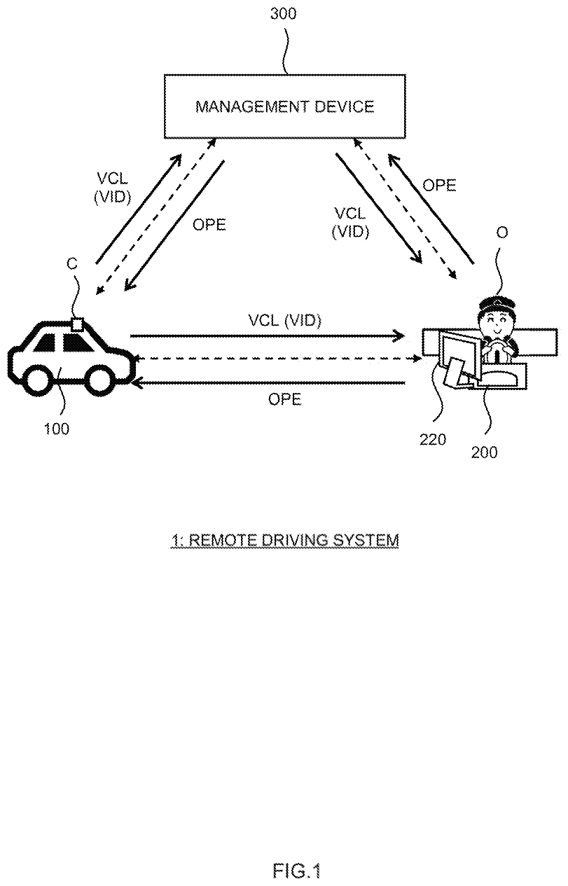

FIG. 1 is a schematic diagram showing a configuration example of a remote driving system 1 according to the present embodiment. The remote driving system 1 includes a vehicle 100, a remote driver terminal 200, and a management device 300. The vehicle 100 is a target of the remote driving by a remote driver O (remote operator). The remote driver terminal 200 is a terminal device that the remote driver O use during the remote driving of the vehicle 100. The remote driver terminal 200 may also be referred to as a remote cockpit. The management device 300 manages the remote driving system 1. Typically, the management device 300 is a management server on a cloud. The management server may be configured by a plurality of servers that perform distributed process.

The vehicle 100, the remote driver terminal 200, and the management device 300 can communicate with each other via a communication network. The vehicle 100 and the remote driver terminal 200 can communicate with each other via the management device 300. The vehicle 100 and the remote driver terminal 200 may directly communicate with each other without the management device 300.

A variety of sensors, including a camera C, are mounted on the vehicle 100. The camera C shoots a surrounding situation of the vehicle 100. The camera C shoots a video VID showing the surrounding situation of the vehicle 100. Vehicle information VCL is information obtained by the sensors, including the video shot by the camera C. The vehicle 100 transmits the vehicle information VCL to the remote driver terminal 200.

The remote driver terminal 200 receives the vehicle information VCL transmitted from the vehicle 100. The remote driver terminal 200 presents the vehicle information VCL to the remote driver O. Specifically, the remote driver terminal 200 includes a display device 220 and displays the video VID etc. on the display device 220. The remote driver O recognizes the surrounding situation of the vehicle 100 by checking the displayed information and performs remote driving of the vehicle 100. Remote operation information OPE is information related to a driving operation (a steering operation, an acceleration operation, or a deceleration operation) by the remote driver O. For example, the remote operation information OPE includes a driving operation amount (a steering operation amount, an acceleration operation amount, a deceleration operation amount) input by the remote driver O. The remote operation information OPE can be said to be information reflecting a degree of intensity of the driving operation by the remote driver O. The remote driver terminal 200 transmits the remote operation information OPE to the vehicle 100.

The vehicle 100 receives the remote operation information OPE transmitted from the remote driver terminal 200. The vehicle 100 performs vehicle travel control in accordance with the received remote operation information OPE. In this way, the remote driving of the vehicle 100 is realized.

### 2. Video Quality Control in Consideration of Active Operation

As described above, the video VID necessary for remote driving is transmitted from the vehicle 100 to the remote driver terminal 200. The remote driver O recognizes the surrounding situation of the vehicle 100 by checking the video VID. Providing the remote driver O with the video VID with high quality is preferable from a viewpoint of accuracy of the remote driving by the remote driver O. However, as the video quality becomes higher, an amount of transmission data and a communication cost increase. The present embodiment proposes a technique capable of ensuring the accuracy of the remote driving and reducing the communication cost.

### 2-1. Active Operation

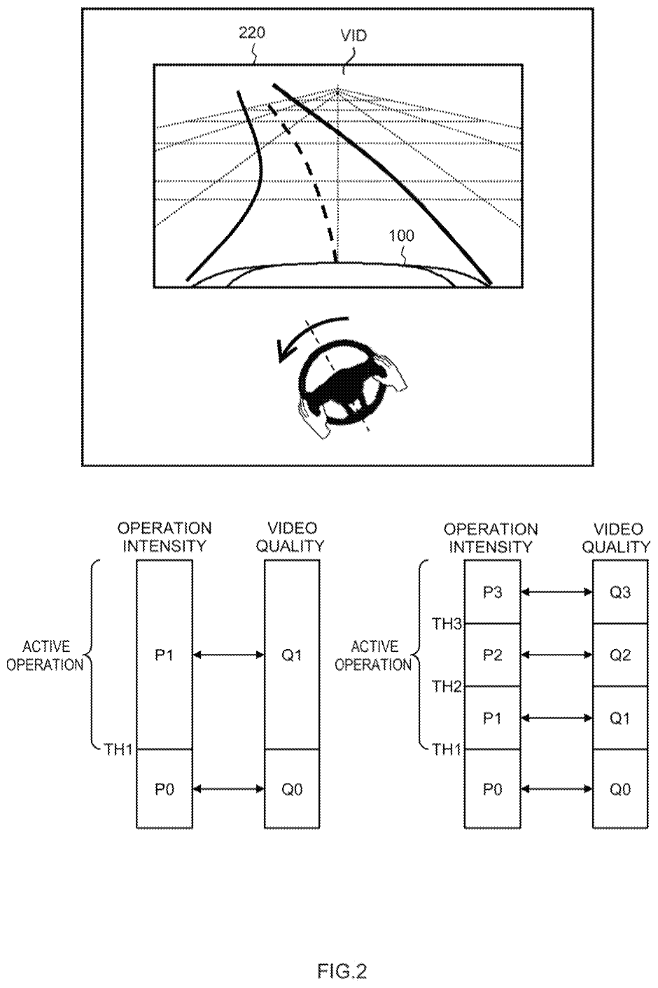

First, an “active operation” by the remote driver O will be described with reference to FIG. 2. The active operation is a driving operation actively performed by the remote driver O. The driving operation is a steering operation (steering wheel operation) to turn the vehicle 100, an acceleration operation (accelerator operation) to accelerate the vehicle 100, or a deceleration operation (braking operation) to decelerate the vehicle 100. For example, the remote driver O actively performs the steering operation when turns the vehicle 100 on a curved road or at an intersection. As another example, the remote driver O actively performs the deceleration operation when makes the vehicle 100 stop in front of an intersection or a traffic light. These are some examples of the active operations. On the contrary, the remote driver O does not perform any particular active operation when the vehicle 100 is traveling on a straight road at a constant speed.

In order to define the active operation by the remote driver O more clearly, the term “operation intensity” is introduced. The operation intensity is the degree of the intensity of the driving operation by the remote driver O. For example, the operation intensity is proportional to a steering amount by the remote driver O. As another example, the operation intensity is proportional to a steering speed by the remote driver O. As still another example, the operation intensity is proportional to a requested acceleration requested by the remote driver O. The required acceleration is proportional to an amount of the acceleration operation by the remote driver O. As still another example, the operation intensity is proportional to the requested deceleration requested by the remote driver O. The required deceleration is proportional to an amount of the deceleration operation by the remote driver O.

The active operation by the remote driver O is the driving operation whose operation intensity exceeds a first threshold value TH1. In FIG. 2, the operation intensity P0 is equal to or less than the first threshold value TH1, and the operation intensity P1 exceeds the first threshold value TH1. Therefore, the driving operation with the operation intensity P1 is the active operation. On the other hand, the driving operation with the operation intensity P0 is not the active operation. For example, the operation intensity when the vehicle 100 is traveling on a straight road at a constant speed is likely to be P0.

The active operation may be divided into a plurality of stages (levels). As an example, a second threshold value TH2 and a third threshold value TH3 will be considered. The second threshold value TH2 is supposed to be higher than the first threshold value TH1, and the third threshold value TH3 is supposed to be even higher than the second threshold value TH2. The operation intensity P1 is higher than the first threshold value TH1 and equal to or less than the second threshold value TH2. The driving operation with the operation intensity P1 is a weak level of the active operation. The operation intensity P2 is higher than the second threshold value TH2 and equal to or lower than the third threshold value TH3. The driving operation with the operation intensity P2 is a medium level of the active operation. The operation intensity P3 exceeds the third threshold value TH3. The driving operation with the operation intensity P3 is a strong level of the active operation.

An “individual habit” of the remote driving may differ depending on the remote driver O. Even in the same scene, the operation intensity P may be different depending on the remote driver O. In consideration of such individuality of the remote driver O, the thresholds including the first threshold value TH1 may be individually set for each remote driver O.

The active operation by the remote driver O can be detected based on the above-described remote operation information OPE. As described later, it is also possible to “predict” that the active operation will be performed before the active operation is actually performed by the remote driver O. Some specific methods for detecting or predicting the active operation will be described in the section 5 below.

### 2-2. Video Quality Control

When performing the remote driving of the vehicle 100, the remote driver O carefully observes the surrounding situation of the vehicle 100. In particular, when performing the active operation, the remote driver O observes the surrounding situation of the vehicle 100 with a special attention. Therefore, when the remote driver O performs the active operation, it is desirable to provide the remote driver O with the high-quality video. This improves the accuracy of the remote driving.

Even without performing the active operation, the remote driver O carefully observes the surrounding situation of the vehicle 100. For example, even when the vehicle 100 is traveling on a straight road at a constant speed, the remote driver O carefully observes the surrounding situation of the vehicle 100. However, even if the video quality is not increased to more than the necessary level, the remote driver O can continue the remote driving of the vehicle 100 with sufficient accuracy when the video VID with normal quality is provided. Rather, by setting the video quality to the normal quality, the amount of transmission data and the communication cost can be reduced.

From the above viewpoint, according to the present embodiment, the quality of the video VID transmitted from the vehicle 100 to the remote driver terminal 200 is dynamically controlled in consideration of the active operation by the remote driver O. Such control of the quality of the video VID is hereinafter referred to as “video quality control”.

Referring again to FIG. 2, the video quality control in consideration of the active operation will be described. A default video quality Q0 are the normal video quality of the video VID. In the case of the operation intensity P0 equal to or less than the first threshold value TH1, the video quality are set to the default video quality Q0. That is, the operation intensity P0 equal to or less than the first threshold value TH1 is associated with the default video quality Q0. The operation intensity P1 exceeding the first threshold value TH1 is associated with the video quality Q1 higher than the default video quality Q0.

According to the present embodiment, when the active operation by the remote driver O is not detected or predicted, the video quality is set to the default video quality Q0. In conjunction with the active operation by the remote driver O being detected or predicted, the video quality increase to the video quality Q1 higher than the default video quality Q0. In other words, the video quality increase to the video quality Q1 higher than the default video quality Q0, with the detection or prediction of the active operation by the remote driver O as a trigger.

When the active operation is divided into the plurality of stages (levels), the video quality is also divided into the plurality of stages (levels). For example, when the weak level of the active operation, corresponding to the operation intensity P1, is detected or predicted, the video quality is set to the video quality Q1 higher than the default video quality Q0. When the medium level of the active operation, corresponding to the operation intensity P2, is detected or predicted, the video quality is set to the video quality Q2 higher than the video quality Q1. When the strong level of the active operation, corresponding to the operation intensity P3, is detected or predicted, the video quality Q2 is set to the video quality Q3 even higher than the video quality Q2.

A variety of examples of processes to improve the video quality can be considered.

A first process to increase the video quality is to increase a frame rate of the video VID. A default frame rate is a frame rate corresponding to the default video quality Q0. In conjunction with the active operation being detected or predicted, the frame rate of the video VID is set to be higher than the default frame rate.

A second process to increase the video quality is to increase a key frame rate of the video VID, in other words, to reduce a key frame interval of the video VID. As is well known, the video VID is composed of a key frame (I frame) and other frames, such as a P frame and a B frame. The key frame holds information of the whole image, and the whole image can be reproduced from the key frame alone. On the other hand, the P frame and the B frame hold only information of a difference from the key frame etc., and the whole image cannot be reproduced the P frame or the B frame alone. If the P frame or the B frame continues, deviation from the actual image may increase. Therefore, transmitting the key frame, which can reproduce the whole image alone, contributes to improving in video quality. A default key frame rate is a key frame rate corresponding to the default video quality Q0. In conjunction with the active operation being detected or predicted, the key frame rate of the video VID is set to be higher than the default key frame rate.

A third process to increase the video quality is to temporarily insert the key frame into the video VID, regardless of a setting of the key frame rate of the video VID. In response to the active operation being detected or predicted, the key frame is immediately inserted into the video VID. For the same reason as in the case of the second process, the video quality is improved also by this process.

A fourth process to increase the video quality is to increase resolution of the video VID. Default resolution is resolution corresponding to the default video quality Q0. In conjunction with the active operation being detected or predicted, the resolution of the video VID is set to be higher than the default resolution.

A plurality of types of process candidates to increase the video quality includes two or more of the first to the fourth processes described above. At least one of the plurality of types of process candidates is selected and executed. Two or more of the plurality of types of process candidates may be selected and executed together. That is, two or more processes may be combined.

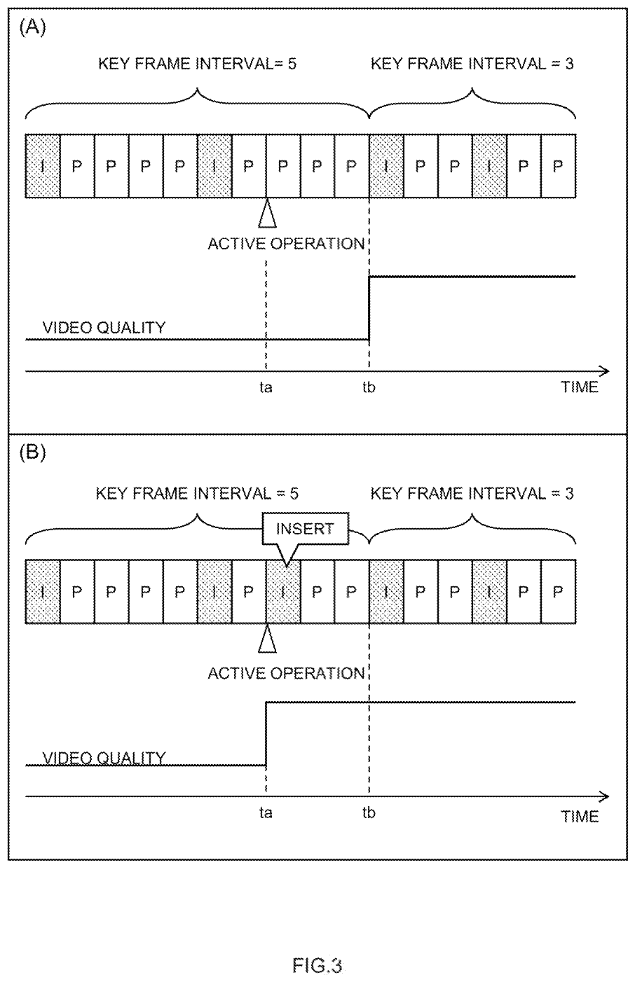

FIG. 3 is a conceptual diagram for explaining an example of the key frame control and shows a key frame configuration of the video VID. The horizontal axis represents time.

Part (A) in FIG. 3 illustrates a case where the second process is executed. The default value of the key frame interval is “5”. At time ta, the active operation is detected or predicted. When the active operation is detected or predicted, the key frame interval is changed to “3”, which is smaller than the default value. However, the key frame interval “3” actually starts to work at the time tb after the time ta. That is, there is a slight time difference (delay) from the detection or prediction of the active operation to the actual improvement of the video quality.

On the other hand, part (B) in FIG. 3 illustrates a case of a combination of the second process and the third process. When the active operation is detected or predicted at time ta, an extra key frame is immediately inserted. Thus, the video quality is immediately improved without the delay. In this way, it is possible to restrain the delay until the video quality is actually improved by combining the third process with the second process.

The first threshold value TH1, which are criteria to determine whether the active operation is performed, may be set independently for each of the plurality of types of process candidates. The first threshold value TH1 may be different for each of the plurality of types of process candidates. For example, the first threshold value TH1 for the second process may be set lower than the first threshold value TH1 for the first process. In this case, the second process is executed preferentially to the first process.

The process to be executed of the plurality of types of process candidates may be determined in accordance with a “type” of the active operation. For example, when the active operation is the acceleration operation, the vehicle speed increases. When the vehicle speed increases, apparent flow of the video VID increases. In particular, the flow of the video VID in the peripheral visual field gets fast. In this case, in order to express the speed of the flow of the video VID, it is effective to increase the frame rate of the video VID. That is, when the active operation is the acceleration operation, at least the first process may be executed.

As another example, when the active operation is the steering operation, the remote driver O increases attentiveness not only in a forward direction but also in right and left directions. That is, the remote driver O pays attention to the video VID over the entire screen. In this case, it is more effective to increase definition of the entire video VID than to express the speed of the flow of the video VID. For this purpose, it is effective to increase the key frame rate of the video VID. That is, when the active operation is the steering operation, at least the second process may be executed.

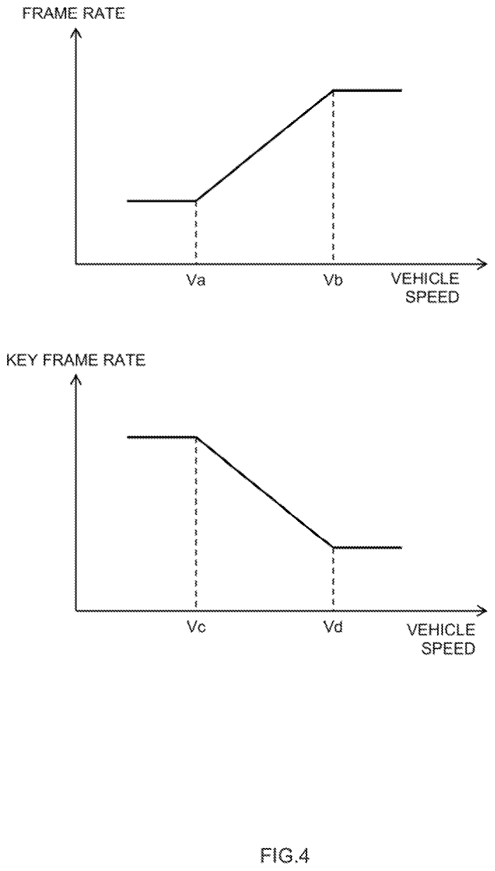

FIG. 4 is a conceptual diagram showing an example of the video quality control in consideration of the vehicle speed of the vehicle 100. In the example shown in FIG. 4, the first process to control the frame rate and the second process to control the key frame rate are executed. The horizontal axis represents the vehicle speed, and the vertical axis represents the frame rate or the key frame rate.

When the vehicle is traveling at high speed, the apparent flow of the video VID gets fast. In particular, the flow of the video VID in the peripheral visual field gets fast. In this case, in order to express the speed of the flow of the video VID, it is effective to increase the frame rate of the video VID. Therefore, the frame rate of the video VID may increase as the vehicle speed increases. In the example shown in FIG. 4, the frame rate increases as the vehicle speed increases during a period in which the vehicle speed increases from Va to Vb. The frame rate in the video quality control is set based on the map as shown in FIG. 4.

On the other hand, during low-speed traveling, the remote driver O increases attentiveness not only in the forward direction but also in the right and left directions. That is, the remote driver O pays attention to the video VID over the entire screen. For example, when the vehicle 100 is driven at a low speed in a parking lot, the remote driver O pays attention to the video VID over the entire screen. In this case, it is more effective to increase the definition of the entire video VID than to express the speed of the flow of the video VID. For this purpose, it is effective to increase the key frame rate of the video VID. That is, the key frame rate of the video VID may increase as the vehicle speed decreases. In the example shown in FIG. 4, the key frame rate increases as the vehicle speed decreases during a period in which the vehicle speed decrease from Vc to Vd. The key frame rate in the video quality control is set based on the map as shown in FIG. 4.

### 2-3. Timing Chart

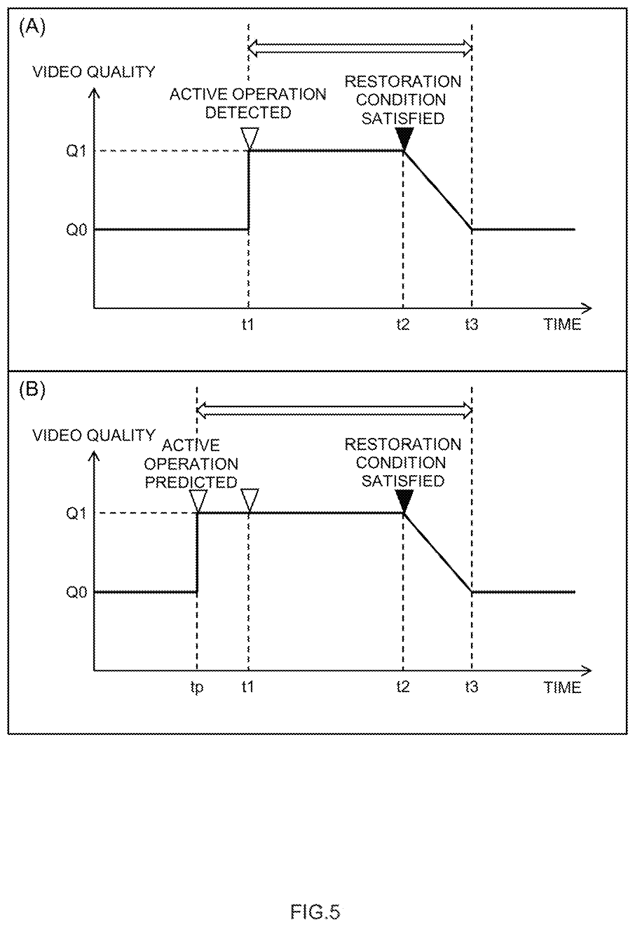

FIG. 5 is a timing chart showing an example of video quality control in consideration of the active operation. The horizontal axis represents time, and the vertical axis represents the video quality.

Part (A) in FIG. 5 illustrates a case where the active operation by the remote driver O is detected. Before the time t1, the video quality is set to the default video quality Q0. At time t1, the active operation is detected. In conjunction with the active operation being detected, the video quality is increased to the video quality Q1 (a first video quality) higher than the default video quality Q0.

A restoration condition is a condition for restoring the video quality from the video quality Q1 (the first video quality) to the default video quality Q0. For example, the restoration condition is that the active operation by the remote driver O is not detected. As another example, the restoration condition is that a certain time has passed since the active operation was detected. At time t1 after time t2, the restoration condition is satisfied. When the restoration condition is satisfied, the video quality is restored from the video quality Q1 to the default video quality Q0.

As shown in FIG. 5, the video quality may gradually change from the video quality Q1 to the default video quality Q0. That is, the time for the video quality to return from the video quality Q1 to the default video quality Q0 may be set to be longer than the time for the video quality to increase from the default video quality Q0 to the video quality Q1. In this case, the remote driver O is less likely to notice deterioration in the video quality. Therefore, the remote driver O less likely to have an uncomfortable feeling.

In the example illustrated in part (A) in FIG. 5, the video quality is higher than the default video quality Q0 during the period from the time t1 to the time t3. The period in which the video quality is higher than the default video quality Q0 is hereinafter referred to as a “first period”. The first period is finite. The default video quality Q0 is the video quality other than in the first period. The video quality is higher than the default video quality Q0 during the first period after the active operation by the remote driver O is detected.

Part (B) in FIG. 5 shows a case where the active operation by the remote driver O is predicted. The active operation is predicted at the time tp before the time t1 at which the active operation is actually performed. In conjunction with the active operation being predicted, the video quality is increased to video quality Q1 (the first video quality) higher than the default video quality Q0. The restoration condition is the same as in the case of part (A) in FIG. 5. In the example shown in part (B) in FIG. 5, the period ranging from time tp to time t3 is the first period. The video quality is higher than the default video quality Q0 during the first period after the active operation by the remote driver O is predicted.

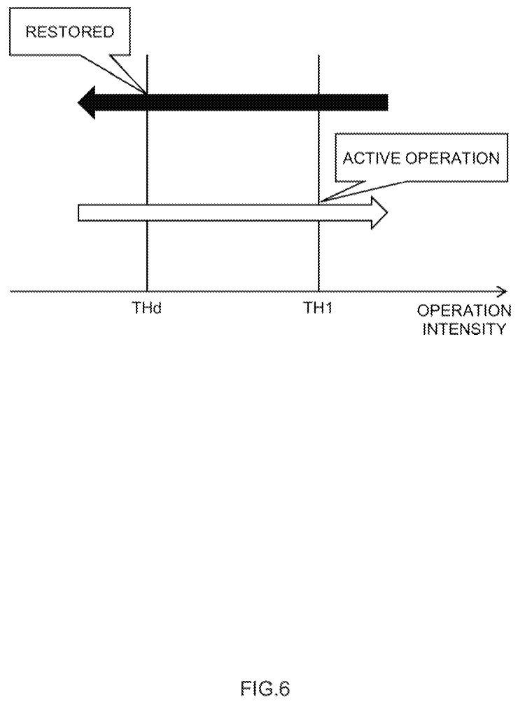

FIG. 6 is a conceptual diagram for explaining an example of detection and restoration of the active operation. The horizontal axis represents the operation intensity by the remote driver O. When the operation intensity exceeds the first threshold value TH1, it is determined that the active operation is performed by the remote driver O. The restoration threshold value THd is a threshold to determine that the active operation is no longer performed by the remote driver O. The restoration condition is that the operation intensity decrease to be equal to or less than the restoration threshold value THd. As shown in FIG. 6, the restoration threshold value THd may be set to be lower than the first threshold value TH1. That is, there may be hysteresis characteristics with respect to the detection and the restoration of the active operation. Such hysteresis characteristics suppress a hunting in the video quality.

### 2-4. Video Transmission System

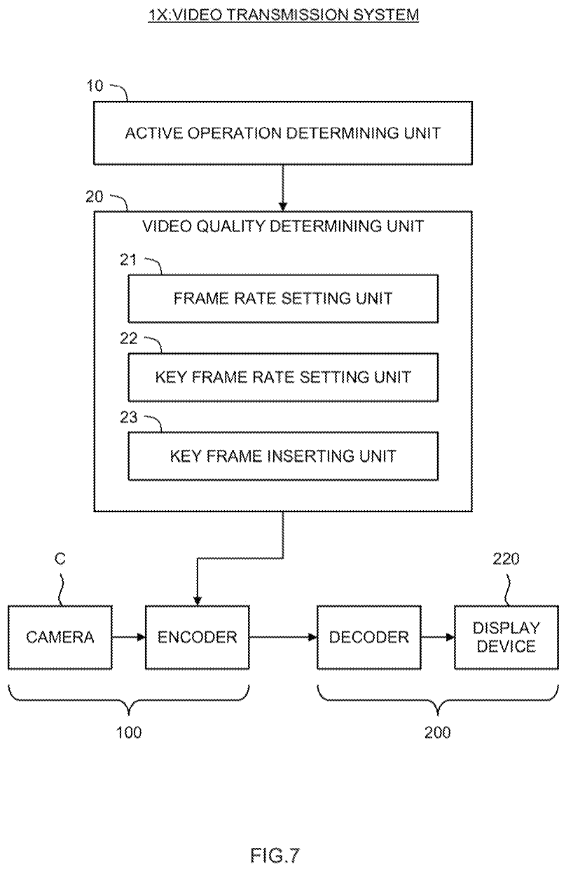

FIG. 7 is a block diagram illustrating an example of a functional configuration of a video transmission system 1X for transmitting the video VID from the vehicle 100 to the remote driver terminal 200. The video transmission system 1X is a part of the remote driving system 1.

The video transmission system 1X includes the camera C and an encoder mounted in the vehicle 100. The camera C acquires the video VID. The encoder encodes the video VID. The vehicle 100 transmits the encoded video VID to the remote driver terminal 200.

The video transmission system 1X includes a decoder and the display device 220 on the remote driver terminal 200. The remote driver terminal 200 receives the video VID transmitted from the vehicle 100. The decoder decodes the received video VID. The display device 220 displays the decoded video VID.

The video transmission system 1X further includes an active operation determining unit 10 and a video quality determining unit 20. The active operation determining unit 10 detects or predicts the active operation by the remote driver O. A specific example of the active operation determining unit 10 will be described in detail in the section 5 below.

The video quality determining unit 20 acquires a result of the determination by the active operation determining unit 10. Then, the video quality determining unit 20 determines control information of the video quality based on the result of the determination by the active operation determining unit 10. For example, the control information of the video quality is a setting value of the frame rate of the video VID. As another example, the control information of the video quality is a setting value of the key frame rate of the video VID. As another example, the video quality control information may be an instruction to insert a temporary key frame into the video VID.

As shown in FIG. 7, the video quality determining unit 20 includes a frame rate setting unit 21, a key frame rate setting unit 22, and a key frame inserting unit 23. The frame rate setting unit 21 sets the frame rate of the video VID based on the result of the determination by the active operation determining unit 10. The key frame rate setting unit 22 sets the key frame rate of the video VID based on the result of the determination by the active operation determining unit 10. The key frame inserting unit 23 generates the instruction to insert the key frame into the video VID based on the result of the determination by the active operation determining unit 10.

The video transmission system 1X controls the encoder mounted in the vehicle 100 in accordance with the video quality control information. Thus, the video quality control according to the present embodiment is realized.

As described above, the vehicle 100, the remote driver terminal 200, and the management device 300 can communicate with each other via the communication network. Therefore, information necessary for the video quality control can be shared between the vehicle 100, the remote driver terminal 200, and the management device 300. Since information necessary for the video quality control can be shared, the active operation determining unit 10 and the video quality determining unit 20 may be included in any of the vehicle 100, the remote driver terminal 200, and the management device 300. The active operation determining unit 10 and the video quality determining unit 20 may be included in different devices. That is, the active operation determining unit 10 and the video quality determining unit 20 may be distributed to the vehicle 100, the remote driver terminal 200, and the management device 300. In general, the active operation determining unit 10 and the video quality determining unit 20 are realized by one or more processors or processing circuitry.

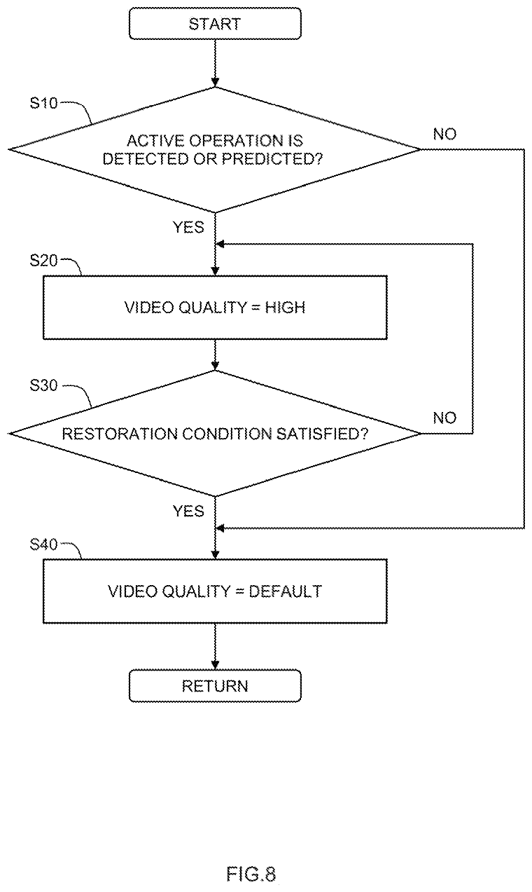

FIG. 8 is a flowchart summarizing the video quality control in consideration of the active operation.

In Step S10, the video transmission system 1X performs an “active operation determination process”. To be more specific, the video transmission system 1X detects or predicts the active operation by the remote driver O. When the active operation is detected or predicted (Step S10; Yes), the process proceeds to Step S20. On the other hand, when the active operation is not detected or predicted (Step S10; No), the process proceeds to Step S40.

In Step S20, the video transmission system 1X performs a “video quality increase process”. To be more specific, the video transmission system 1X sets the video quality of the video VID to be higher than the default video quality Q0. Thereafter, the process proceeds to Step S30.

In Step S30, the video transmission system 1X determines whether the restoration condition is satisfied. When the restoration condition is not satisfied (Step S30; No), the process returns to Step S20. On the other hand, when the restoration condition is satisfied (Step S30; Yes), the process proceeds to Step S40.

In step S40, the video transmission system 1X sets the video quality of the video VID to the default video quality Q0.

### 2-5. Effect

As described above, according to the present embodiment, the video quality of the video VID transmitted from the vehicle 100 to the remote driver terminal 200 is not uniformly set but is dynamically changed. Specifically, the video quality increases for the first period after the active operation by the remote driver O is detected or predicted. When performing the active operation, the remote driver O observes the surrounding situation of the vehicle 100 particularly carefully. At this time, the video quality increases, and thus the accuracy of the remote driving by the remote driver O improves.

The video quality of the video VID in the period other than the first period is set to be lower than that in the first period. Since the remote driver O does not perform the active operation during the period other than the first period, the accuracy of remote driving is secured without increasing the video quality more than a necessary level. Even though the video VID with normal quality is provided, the remote driver O can continue the remote driving of the vehicle 100 with sufficient accuracy. Since the video quality is set to be relatively low, the amount of transmission data and the communication cost are both reduced.

As described above, according to the present embodiment, it is possible to ensure the accuracy of remote driving and to reduce the communication cost. In other words, according to the present embodiment, it is possible to achieve both the securement of the accuracy of remote driving and the reduction of the communication cost.

### 3. Example of Vehicle

### 3-1. Configuration Example

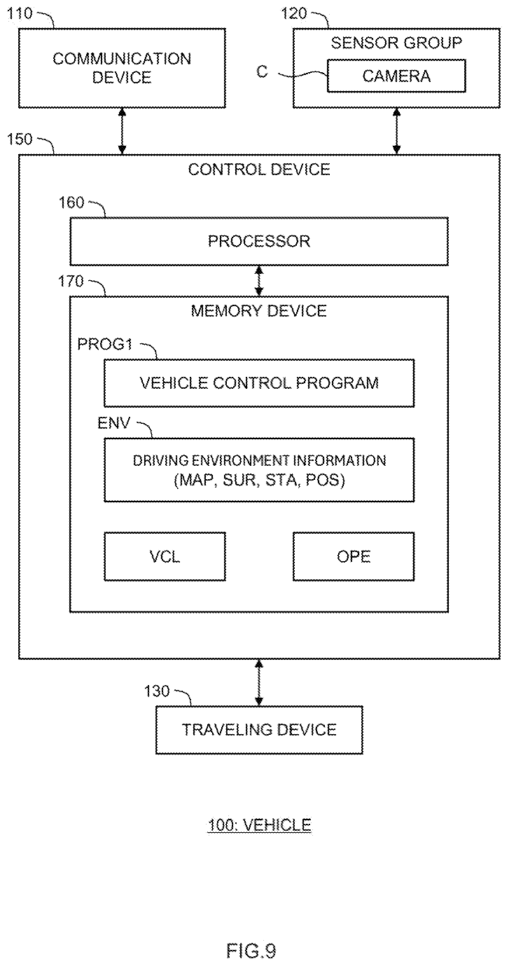

FIG. 9 is a block diagram showing a configuration example of the vehicle 100. The vehicle 100 includes a communication device 110, a sensor group 120, a travel device 130, and a control device 150.

The communication device 110 communicates with the outside of the vehicle 100. For example, the communication device 110 communicates with the remote driver terminal 200 and the management device 300. The communication device 110 may include the encoder (see FIG. 7) that encodes the video VID.

The sensor group 120 includes a recognition sensor, a vehicle state sensor, a position sensor, etc. The recognition sensor recognizes (detects) the surrounding situation of the vehicle 100. Examples of the recognition sensor include the camera C, a laser imaging detection and ranging (LIDAR), and a radar. The vehicle state sensor detects a state of the vehicle 100. The vehicle state sensor includes a speed sensor, an acceleration sensor, a yaw rate sensor, a steering angle sensor, etc. The position sensor detects the position and the orientation of the vehicle 100. For example, the position sensor includes a global navigation satellite system (GNSS).

The travel device 130 includes a steering device, a driving device, and a braking device. The steering device steers wheels. For example, the steering device includes an electric power steering (EPS) device. The driving device is a power source that generates a driving force. Examples of the driving device include an engine, an electric motor, and an in-wheel motor. The braking device generates a braking force.

The control device 150 is a computer that controls the vehicle 100. The control device 150 includes one or more processors 160 (hereinafter, simply referred to as a processor 160) and one or more memory devices 170 (hereinafter, simply referred to as a memory device 170). The processor 160 executes a variety of processes. Examples of the processor 160 include a central processing unit (CPU), a graphics processing unit (GPU), an application specific integrated circuit (ASIC), and a field-programmable gate array (FPGA). The processor 160 can be referred as “processing circuitry”. The memory device 170 stores a variety of types of information. Examples of the memory device 170 include a volatile memory, a nonvolatile memory, a hard disk drive (HDD), and a solid-state drive (SSD).

The vehicle control program PROG1 is a computer program executed by the processor 160. Functions of the control device 150 may be realized by cooperation between the processor 160 that executes the vehicle control program PROG1 and the memory device 170. The vehicle control program PROG1 is stored in the memory device 170. Alternatively, the vehicle control program PROG1 may be recorded in a non-transitory computer-readable recording medium.

### 3-2. Driving Environment Information

The control device 150 acquires driving environment information ENV indicating the driving environment of the vehicle 100. The driving environment information ENV is stored in the memory device 170.

The driving environment information ENV includes map information MAP. The map information MAP includes a general navigation map. The map information MAP may indicate lane configuration and road shapes. The map information MAP may include position information of intersections, stop lines, traffic lights, signs, etc. The control device 150 acquires map information MAP of a necessary area from the map database. The map database may be stored in the memory device 170 or may be stored in a map management device external to the vehicle 100. In the latter case, the control device 150 communicates with the map management device via the communication device 110 and acquires the necessary map information MAP.

The driving environment information ENV includes surrounding situation information SUR indicating a result of recognition by the recognition sensor. For example, the surrounding situation information SUR includes the video VID shot by the camera C. The surrounding situation information SUR may include object information regarding an object around the vehicle 100. Examples of the object around the vehicle 100 include a pedestrian, another vehicle (a preceding vehicle, a parking vehicle, etc.), a white line, a stop line, a traffic light, a sign, a roadside structure, etc. The object information indicates a relative position and a relative speed of the object with respect to the vehicle 100. For example, by analyzing the video VID obtained by the camera C, the object can be identified and the relative position of the object can be calculated. In addition, it is possible to identify the object based on the point group information obtained by the LIDAR and acquire the relative position and the relative speed of the object.

Further, the driving environment information ENV includes vehicle state information STA indicating a result of the detection by the vehicle state sensor. The vehicle state information STA indicates the vehicle speed, the acceleration (longitudinal acceleration, lateral acceleration), the yaw rate, the steering angle, etc., of the vehicle 100.

Further, the driving environment information ENV includes vehicle position information POS indicating a position and a moving direction (orientation) of the vehicle 100. The vehicle position information POS is obtained by the position sensor. The vehicle position information POS with high accuracy may be acquired by a localization process with the map information MAP and the surrounding situation information SUR (object information).

### 3-3. Vehicle Travel Control

The control device 150 executes the vehicle travel control for controlling the travel of the vehicle 100. The vehicle travel control includes steering control, driving control, and braking control. The control device 150 executes vehicle travel control by controlling the travel device 130 (the steering device, the driving device, and the braking device).

The control device 150 may execute the autonomous driving control based on the driving environment information ENV. The autonomous driving means that at least a part of steering, acceleration, and deceleration of the vehicle 100 is automatically performed independently of an operation of a driver. More specifically, the control device 150 generates a travel plan of the vehicle 100 based on the driving environment information ENV. Further, the control device 150 generates a target trajectory necessary for the vehicle 100 to travel in accordance with the travel plan, based on the driving environment information ENV. The target trajectory includes a target position and a target velocity. Then, the control device 150 performs the vehicle travel control so that the vehicle 100 follows the target trajectory.

### 3-4. Processes Related to Remote Driving

Hereinafter, a case where the remote driving of the vehicle 100 is performed will be described. The control device 150 communicates with the remote driver terminal 200 via the communication device 110.

The control device 150 transmits the vehicle information VCL to the remote driver terminal 200. The vehicle information VCL is information necessary for remote driving by the remote driver O and includes at least a part of the driving environment information ENV described above. In particular, the vehicle information VCL includes the video VID captured by the camera C. The vehicle information VCL may include other surrounding situation information SUR. The vehicle information VCL may include the vehicle state information STA. The vehicle information VCL may include the vehicle position information POS.

The control device 150 receives the remote operation information OPE from the remote driver terminal 200. The remote operation information OPE is information related to remote driving by the remote driver O. For example, the remote operation information OPE includes a driving operation amount input by the remote driver O. The control device 150 performs vehicle travel control in accordance with the received remote operation information OPE.

The control device 150 may have both functions of the active operation determining unit 10 and the video quality determining unit 20 illustrated in FIG. 7. The video quality determining unit 20 determines control information of the video quality based on the result of the determination by the active operation determining unit 10. The control device 150 controls the encoder in accordance with the control information of the video quality.

The control device 150 may not include the function of the active operation determining unit 10 and may include the function of the video quality determining unit 20. In this case, the control device 150 acquires information on the result of the determination by the external active operation determining unit 10 via the communication device 110.

The active operation determining unit 10 and the video quality determining unit 20 may be installed outside the vehicle 100. In this case, the control device 150 determines the control information of the video quality determined by the video quality determining unit 20 via the communication device 110. The control device 150 controls the encoder in accordance with the control information of the video quality.

### 4. Configuration Example of Remote Driver Terminal

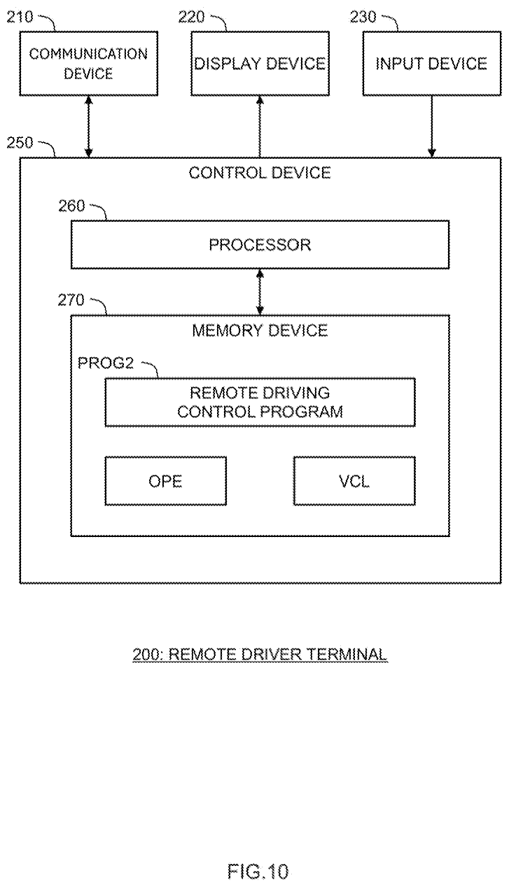

FIG. 10 is a block diagram showing an example of a configuration of the remote driver terminal 200. The remote driver terminal 200 includes a communication device 210, a display device 220, an input device 230, and a control device 250.

The communication device 210 communicates with the vehicle 100 and the management device 300. The communication device 110 may include the decoder (see FIG. 7) that decodes the video VID.

The display device 220 displays a variety of information for the remote driver O performing the remote driving. In other words, the display device 220 presents the variety of information to the remote driver O by displaying the variety of information. The display device 220 may be a touch panel.

The input device 230 receives an input from the remote driver O. For example, the input device 230 includes a remote driving member operated by the remote driver O when the remote driver O performs the remote driving of the vehicle 100. The remote driving member includes a steering wheel, an accelerator pedal, a brake pedal, a direction indicator, etc.

The control device 250 controls the remote driver terminal 200. The control device 250 includes one or more processors 260 (hereinafter, simply referred to as a processor 260) and one or more memory devices 270 (hereinafter, simply referred to as a memory device 270). The processor 260 executes various processes. Examples of the processor 260 include a CPU, a GPU, an ASIC, and an FPGA. The processor 260 can be referred as “processing circuitry”. The memory device 270 stores various kinds of information. Examples of the memory device 270 include a volatile memory, a nonvolatile memory, an HDD, and an SSD.

The remote driving control program PROG2 is a computer program executed by the processor 260. The function of the control device 250 may be realized by cooperation between the processor 260 that executes the remote driving control program PROG2 and the memory device 270. The remote driving control program PROG2 is stored in the memory device 270. Alternatively, the remote driving control program PROG2 may be recorded in a non-transitory computer-readable recording medium. The remote driving control program PROG2 may be provided via a network.

The control device 250 communicates with the vehicle 100 via the communication device 210. The control device 250 receives the vehicle information VCL transmitted from the vehicle 100. The control device 250 presents the vehicle information VCL to the remote driver O by displaying the vehicle information VCL including the video VID to the remote driver O on the display device 220. The remote driver O can recognize the state of the vehicle 100 and the surrounding situation based on the vehicle information VCL displayed on the display device 220.

The remote driver O operates the remote driving member of the input device 230. The operation amount of the remote driving member is detected by a sensor installed in the remote driving member. The control device 250 generates the remote operation information OPE reflecting the operation amount of the remote driving member input by the remote driver O. The remote operation information OPE can be said to be information reflecting the degree of the intensity of the driving operation by the remote driver O. Then, the control device 250 transmits the remote operation information OPE to the vehicle 100 via the communication device 210.

The control device 250 may have the function of the active operation determining unit 10 illustrated in FIG. 7. In this case, the control device 250 transmits information on the result of the determination by the active operation determining unit 10 to the vehicle 100 via the communication device 210.

The control device 250 may have both functions of the active operation determining unit 10 and the video quality determining unit 20 illustrated in FIG. 7. The video quality determining unit 20 determines the control information of video quality based on the result of the determination by the active operation determining unit 10. The control device 250 transmits the control information of the video quality to the vehicle 100 via the communication device 210.

### 5. Examples of Active Operation Determination Unit

Some examples of the active operation determining unit 10 that detects or predicts the active operation by the remote driver O will be described below.

### 5-1. First Example

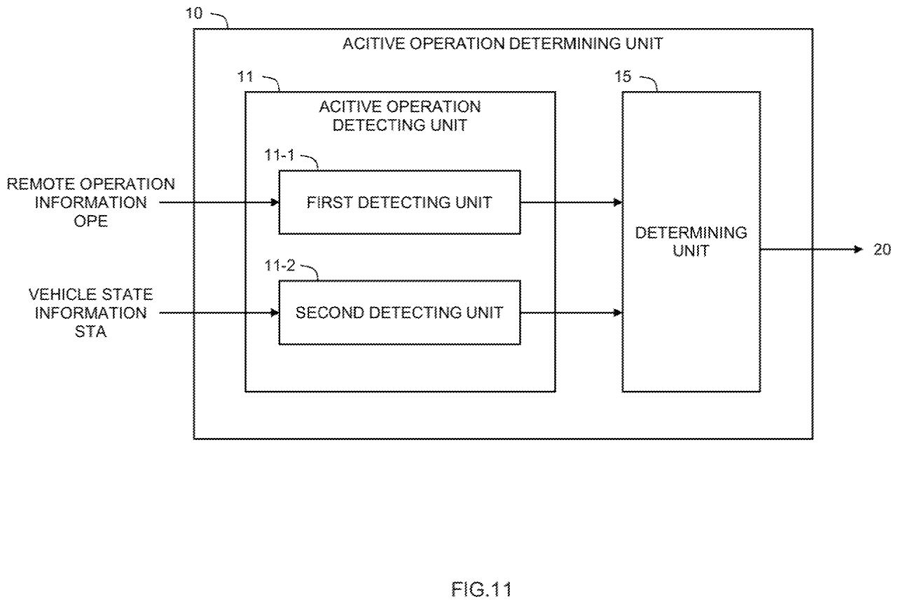

FIG. 11 is a block diagram showing a first example of the active operation determining unit 10. The active operation determining unit 10 includes an active operation detecting unit 11 and a determining unit 15. The active operation detecting unit 11 detects the active operation by the remote driver O. In the example illustrated in FIG. 11, the active operation detecting unit 11 includes a first detecting unit 11-1 and a second detecting unit 11-2.

The first detecting unit 11-1 detects the active operation by the remote driver O based on the remote operation information OPE. As described above, the remote operation information OPE reflects the degree of the intensity of the driving operation (operation intensity) by the remote driver O. For example, the operation intensity is proportional to the steering amount by the remote driver O. As another example, the operation intensity is proportional to the steering speed by the remote driver O. As still another example, the operation intensity is proportional to the requested acceleration requested by the remote driver O. As still another example, the operation intensity is proportional to the requested deceleration requested by the remote driver O. The first detecting unit 11-1 determines whether the operation intensity by the remote driver O exceeds the first threshold value TH1 based on the remote operation information OPE, and detects the active operation. The first threshold value TH1 differs for each type of the operation intensity. The first detecting unit 11-1 may detect the active operation based on a map indicating a correspondence between the operation intensity and the active operation.

The second detecting unit 11-2 detects the active operation by the remote driver O based on the vehicle state information STA. The remote driving of the vehicle 100 by the remote driver O is reflected in the behavior of the vehicle 100. Therefore, it is possible to detect the active operation by the remote driver O based on the vehicle state information STA. For example, when the longitudinal acceleration of the vehicle 100 exceed the first threshold value TH1, the second detecting unit 11-2 detects the active operation. As another example, when the yaw rate or the lateral acceleration exceeds the first threshold value TH1, the second detecting unit 11-2 detects the positive operation. The first threshold value TH1 differs for each vehicle state. The second detecting unit 11-2 may detect the active operation based on the map indicating a correspondence between the vehicle state information STA and the active operation.

The first threshold value TH1 or the map may be individually set for each of the remote driver O. The active operation may be divided into a plurality of stages (levels) (see FIG. 2).

The first detecting unit 11-1 and the second detecting unit 11-2 output the result of the detection to the determining unit 15. The result of the detection includes the presence or absence of detection of the active operation, the content (type) of the detected active operation, etc.

The determining unit 15 receives the result of detection by the first detecting unit 11-1 and the result of detection by the second detecting unit 11-2. When the active operation is detected by at least one of the first detecting unit 11-1 and the second detecting unit 11-2, the determining unit 15 determines that the active operation is performed by the remote driver O. The determining unit 15 notifies the video quality determining unit 20 of the result of the determination. The determining unit 15 may notify the video quality determining unit 20 of the content (type) of the detected active operation.

When the remote driver O performs the remote driving of the vehicle 100, the remote operation information OPE changes at a timing earlier than the vehicle state information STA does. Therefore, basically, the first detecting unit 11-1 detects the active operation earlier than the second detecting unit 11-2.

### 5-2. Second Example

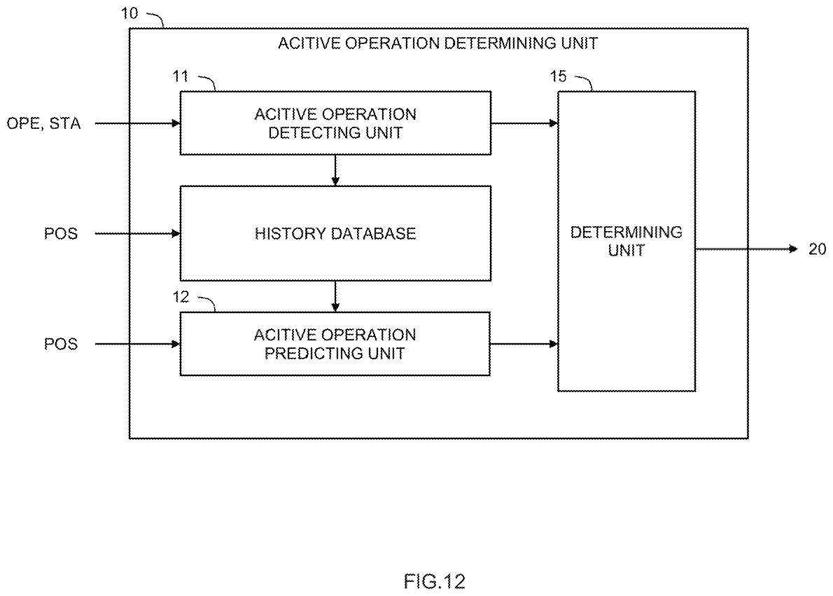

FIG. 12 is a block diagram showing a second example of the active operation determining unit 10. In addition to the active operation detecting unit 11 described in the first example, the active operation determining unit 10 includes a history database and an active operation predicting unit 12.

The history database indicates a position where the active operation was detected in the past. When the active operation is detected by the active operation detecting unit 11, the active operation determining unit 10 registers the position of the vehicle 100 at the timing when the active operation is detected in the history database. The position of the vehicle 100 is obtained from the vehicle position information POS. The history database may associate the position where the active operation was detected in the past with the moving direction of the vehicle 100 at that time. The moving direction of the vehicle 100 is obtained from the vehicle position information POS. The history database may associate the content of the active operation with the position where the active operation is detected.

In a scene where a certain remote driver O performs the active operation, the same remote driver O or another remote driver O is likely to perform the active operation. Thus, by utilizing the history database, it is possible to “predict” that the active operation is performed in the near future.

More specifically, the active operation predicting unit 12 acquires the vehicle position information POS. The vehicle position information POS indicates the current position and the moving direction of the vehicle 100. The active operation predicting unit 12 predicts that the active operation is performed on the road ahead of the vehicle 100, based on the history database and the current position and the moving direction of the vehicle 100. In other words, the active operation predicting unit 12 predicts the occurrence of the active operation that the remote driver O is likely to perform in the near future, based on the history database and the current position and the moving direction of the vehicle 100. The active operation predicting unit 12 outputs the result of the prediction to the determining unit 15. The result of the prediction includes the presence or absence of the predicted active operation, the content (type) of the predicted active operation, etc.

The determining unit 15 receives the detection result by the active operation detecting unit 11 and the result of the prediction by the active operation predicting unit 12, and integrates them. The determining unit 15 may weigh the result of the detection by the active operation detecting unit 11 and the result of the prediction by the active operation predicting unit 12. When the active operation is detected or predicted, the determining unit 15 notifies the video quality determining unit 20 of the fact. The determining unit 15 may notify the video quality determining unit 20 of the content (type) of the detected or predicted active operation.

### 5-3. Third Example

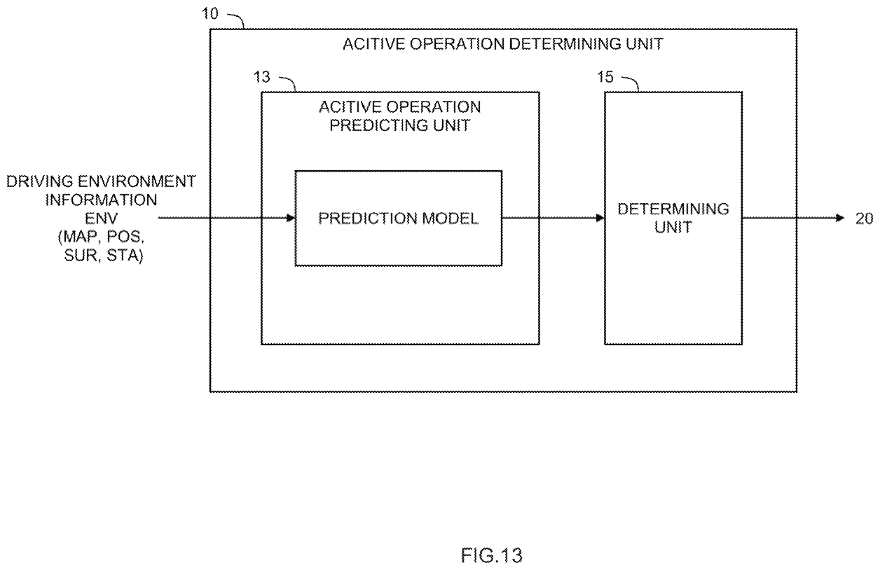

FIG. 13 is a block diagram showing a third example of the active operation determining unit 10. The active operation determining unit 10 includes an active operation predicting unit 13. The active operation predicting unit 13 grasps the situation of the road ahead of the vehicle 100 based on the driving environment information ENV and predicts that the active operation is performed on the road ahead.

For example, when the road ahead of the vehicle 100 is largely curved, it is predicted that the remote driver O will actively perform steering. The shape of the road ahead of the vehicle 100 is obtained from the map information MAP. As another example, when there is an intersection, a stop line, a stop sign, or a traffic light in front of the vehicle 100, it is predicted that the remote driver O actively decelerates. Position information of the intersection, the stop line, the traffic light, the sign, etc. are registered in the map information MAP. The current position and the moving direction of the vehicle 100 are obtained from the vehicle position information POS. The active operation predicting unit 13 grasps the situation of the road in front of the vehicle 100 based on the vehicle position information POS and the map information MAP. Then, the active operation predicting unit 13 predicts the occurrence of the active operation on the road ahead of the vehicle 100 based on the situation of the road ahead of the vehicle 100.

Instead of the map information MAP, the situation of the road ahead of the vehicle 100 can be grasped based on the surrounding situation information SUR indicating the result of recognition by the recognition sensor. In this case, the active operation predicting unit 13 grasps the situation of the road in front of the vehicle 100 based on the vehicle position information POS and the surrounding situation information SUR. Then, the active operation predicting unit 13 predicts the occurrence of the active operation on the road ahead of the vehicle 100 based on the situation of the road ahead of the vehicle 100.

In addition to the situation of the road in front of the vehicle 100, the active operation predicting unit 13 may consider the vehicle speed, because the remote driver O is more likely to actively decelerate as the vehicle speed increases. In this case, the active operation predicting unit 13 predicts the occurrence of the active operation on the road in front of the vehicle 100 in consideration of the vehicle state information STA.

For the prediction process in the active operation predicting unit 13, a prediction model may be used, which is generated in advance through machine learning such as deep learning. The input to the prediction model is the driving environment information ENV, and the output from the prediction model is the presence or absence of the active operation and the content of the active operation.

The active operation predicting unit 13 outputs the result of the prediction to the determining unit 15. The result of the prediction includes the presence or absence of the prediction of the active operation, the content (type) of the predicted active operation, etc.

The determining unit 15 receives the result of the prediction by the active operation predicting unit 13. When the active operation is predicted, the determining unit 15 notifies the video quality determining unit 20 of the fact. The determining unit 15 may notify the video quality determining unit 20 of the predicted content (type) of the active operation.

### 5-4. Fourth Example

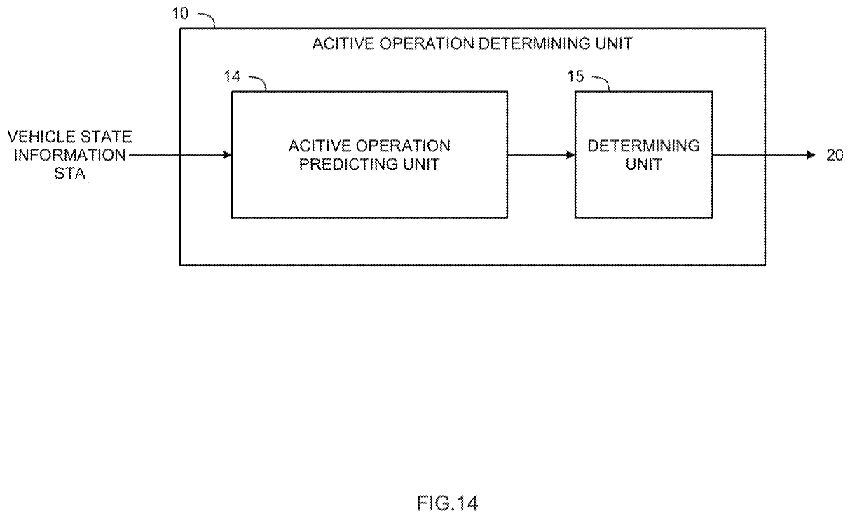

FIG. 14 is a block diagram showing a fourth example of the active operation determining unit 10. The active operation determining unit 10 includes an active operation predicting unit 14 and the determining unit 15. The active operation predicting unit 14 predicts the active operation by the remote driver O based on the vehicle state information STA.

For example, when the vehicle 100 skids due to a strong side wind, the remote driver O is likely to actively perform the steering operation to return the vehicle 100 to the original lateral position and stabilize the vehicle 100. Therefore, when the lateral acceleration exceeds the first threshold value TH1, the active operation predicting unit 14 predicts the active operation by the remote driver O. The determining unit 15 is the same as that in the third example.

### 5-5. Fifth Example

Two or more of the examples of the active operation determining unit 10 described above can be combined.

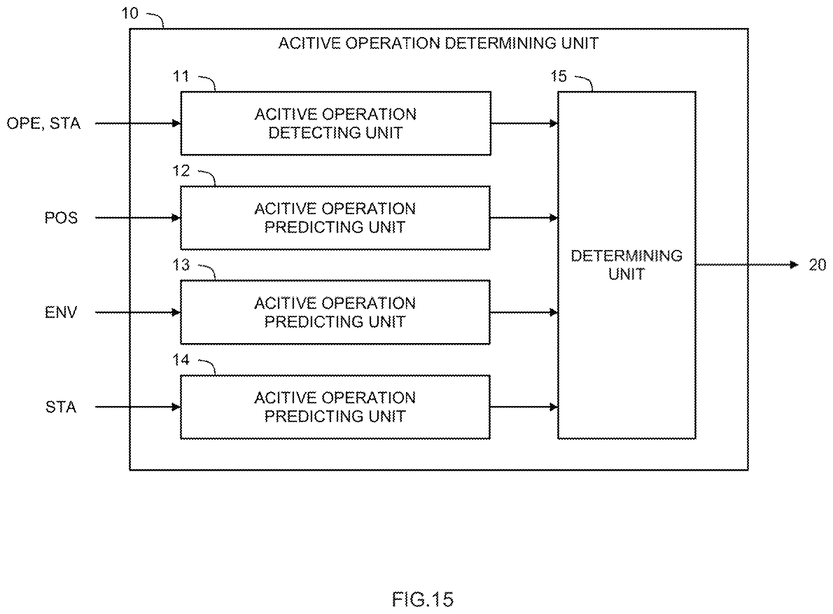

FIG. 15 is a block diagram showing a fifth example of the active operation determining unit 10. In the example illustrated in FIG. 15, the active operation determining unit 10 includes the active operation detecting unit 11 and the active operation predicting unit 12 to 14. The determining unit 15 receives the result of the detection by the active operation detecting unit 11 and the result of the prediction by the active operation predicting unit 12 to 14, and integrates them. The determining unit 15 may weigh the result of the detection by the active operation detecting unit 11 and the result of the prediction by the active operation predicting unit 12 to 14. When the active operation is detected or predicted, the determining unit 15 notifies the video quality determining unit 20 of the fact. The determining unit 15 may notify the video quality determining unit 20 of the content (type) of the detected or predicted active operation.

What is claimed is:

1. A video transmission system for transmitting a video from a moving body that is a target of remote driving by a remote driver to a terminal on a side of the remote driver,
the video transmission system comprising processing circuitry configured to execute:
an active operation determining process to detect or predict an active operation in which a degree of intensity of a driving operation by the remote driver exceeds a first threshold value; and
a video quality increase process to increase quality of the video transmitted to the terminal during a first period after the active operation is detected or predicted, as compared with during a period other than the first period.

2. The video transmission system according to claim 1, wherein
the video quality increase process includes inserting a key frame into the video in response to the active operation being detected or predicted, regardless of a setting of a key frame rate of the video.

3. The video transmission system according to claim 1, wherein
the video quality increase process includes setting a key frame rate of the video during the first period to be higher than that in the period other than the first period.

4. The video transmission system according to claim 1, wherein
a plurality of types of process candidates includes two or more of:
a first process to set a frame rate of the video in the first period to be higher than that in the period other than the first period;
a second process to set a key frame rate of the video in the first period to be higher than that in the period other than the first period; and
a third process to insert a key frame into the video in response to the active operation being detected or predicted, regardless of a setting of the key frame rate of the video, and
the video quality increase process includes executing at least one of the plurality of types of process candidates.

5. The video transmission system according to claim 4, wherein
the first threshold value is independently set for each of the plurality of types of process candidates.

6. The video transmission system according to claim 4, wherein
the video quality increase process includes determining one or more of the plurality of types of process candidates to be executed, in accordance with a type of the active operation.

7. The video transmission system according to claim 6, wherein
the video quality increase process includes:
executing at least the first process when the active operation is an acceleration operation; and
executing at least the second process when the active operation is a steering operation.

8. The video transmission system according to claim 4, wherein
the video quality increase process includes:
increasing the frame rate of the video in the first period as a speed of the moving body increases; and
increasing the key frame rate of the video in the first period as the speed of the moving body decreases.

9. The video transmission system according to claim 1, wherein
default video quality is the quality of the video in the period other than the first period, and
the video quality increase process includes:
increasing the quality of the video to a first video quality higher than the default video quality in conjunction with the active operation being detected or predicted; and
restoring the quality of the video from the first video quality to the default video quality when a restoration condition is satisfied after the quality of the video is increased.

10. The video transmission system according to claim 9, wherein
the video quality increase process includes setting a time to restore the quality of the video from the first video quality to the default video quality to be longer than a time to increase the quality of the video from the default video quality to the first video quality.

11. The video transmission system according to claim 9, wherein
the restoration condition is that the degree of the intensity of the driving operation by the remote driver becomes a restoration threshold value or less, and
the restoration threshold value is lower than the first threshold value.

12. The video transmission system according to claim 1, wherein
the active operation determining process includes:
acquiring remote operation information reflecting the degree of the intensity of the driving operation by the remote driver; and
determining whether the degree of the intensity of the driving operation exceeds the first threshold value based on the remote operation information to detect the active operation.

13. The video transmission system according to claim 12, wherein
the active operation determining process includes:
accessing a history database indicating a position where the active operation is detected in a past;
acquiring information on a current position and a moving direction of the moving body; and
predicting the active operation that is potentially performed on a road ahead of the moving body based on the history database, and the current position and the moving direction of the moving body.

14. The video transmission system according to claim 1, wherein
the active operation determining process includes:
acquiring information on a current position and a moving direction of the moving body;
recognizing a situation of a road ahead of the moving body based on map information or a result of recognition by a recognition sensor mounted on the moving body; and
predicting the active operation that is potentially performed on the road ahead of the moving body based on the situation of the road ahead of the moving body.

15. A video transmission method for transmitting a video from a moving body that is a target of remote driving by a remote driver to a terminal on a side of the remote driver,
the video transmission method comprising:
an active operation determining process to detect or predict an active operation in which a degree of intensity of the driving operation by the remote driver exceeds a first threshold value; and
a video quality increase process to increase quality of the video transmitted to the terminal during a first period after the active operation is detected or predicted, as compared with during a period other than the first period.
